(19) United States
(12) Patent Application Publication
(10) Pub. No.: US 2005/0102513 A1
(43) Pub. Date: May 12, 2005

(54) Enforcing authorized domains with domain membership vouchers

(75) Inventor: Jukka Alve, Helsinki (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 10/703,454

(22) Filed: Nov. 10, 2003

(51) Int. Cl. H04L 9/00

(52) U.S. Cl. 713/168

(57) ABSTRACT

Domain membership vouchers are transmitted to devices in response to domain membership requests and domain joining requests. These vouchers include domain identifiers and domain keys encrypted with the public keys of the requesting devices. Once received, the domain membership vouchers establish the devices as members of authorized domains. Such authorized domains allow the sharing of protected content among devices within a particular authorized domain.

### FIELD OF THE INVENTION

The present invention relates to communications. More particularly, the present invention relates to techniques for managing the distribution of content.

### BACKGROUND OF THE INVENTION

Content, such as television broadcasts, music, video, and Internet content are valuable commodities in the current economy. Accordingly, there is an interest in protecting such content from illegal copying. However, there is also a need to allow the sharing of content between multiple devices owned by a single user.

Digital rights management (DRM) systems typically use cryptographic techniques to bind the content to a certain device, so that illegally made copies cannot be used on other devices. A method that has been proposed for the Open Mobile Alliance, as well as the digital video broadcasting (DVB) copy protection and copy management (CPCM) body involves encrypting the content with a symmetric cryptoalgorithm such as the advanced encryption standard (AES) with a key called a content key at the server side.

The content key is then placed in a data structure called voucher along with other information that controls the content usage, and the voucher (or at least the critical part of it) is encrypted with the Public Device Key, using an asymmetric cryptoalgorithm, such as the Rivest, Shamir, Adleman (RSA) algorithm. This traditional approach causes problems for a user who owns several devices that he or she would like to use to consume the content, because the content will not play on other devices, even if they belong to the same user.

Since content represents a substantial investment to the user, the user may be discouraged from purchasing new devices if the new devices will not have access to already purchased content.

The Call for Proposals for Content Protection and Copy Management Technologies by the DVB-CPT (DVB—copy protection technology) body introduced a new concept called an authorized domain. The authorized domain covers all compliant devices owned or rented by the same user. The intention is that within such a domain, the content should be able to move freely from device to device, so that the user can enjoy the content on any of his or her devices.

A proposal for DVB Content Protection and Copy Management Technologies outlined a system which would meet the requirements set forth by DVB-CPT for that particular system. This proposal involved a symmetric key called a domain key. The domain key was to be used as an optional encryption layer to protect content keys in vouchers, depending on whether the usage state restricts access to the content to the authorized domain. The proposal also mentioned that the domain key could be issued by a service provider. It was proposed that secure socket layer (SSL) communications would be used to protect the domain keys in transit. In addition, it was proposed that secure storage would be needed in the device to protect the domain key once it gets there. However, this proposal does not address the mechanics involving the establishment and modification of authorized domains.

### SUMMARY OF THE INVENTION

The present invention is directed to a method and system for establishing an authorized domain. The method and system receive from a remote device a domain establishment request, which includes a public key of the remote device. The request may also include a certificate indicating that the public key belongs to a trusted device. The method and system may also determine whether the certificate is valid.

In response to the request, a domain identifier encrypted with the public key and a domain key encrypted with the public key are sent to the remote device. The domain key is adapted to decrypt content authorized for consumption within the domain. The domain identifier and the domain key may be sent to the remote device in a voucher. This voucher may also include a domain membership expiration time.

The present invention is also directed to a method and system for adding a device to an existing authorized domain. This method and system receives a domain joining request including a domain identifier and a public key of a remote device. In response, a domain identifier encrypted with the public key and a domain key encrypted with the public key are sent to the remote device. The domain joining request may be received from the remote device. Alternatively, this request may be received from a second remote device currently belonging to the existing authorized domain specified by the domain identifier.

An advantage of the present invention is that it simplifies the sharing of content. Rather than purchasing the same content multiple times for different devices, new devices may join an existing domain, thereby gaining access to previously acquired content within that domain.

Further features and advantages of the present invention will become apparent from the following description, claims, and accompanying drawings.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a diagram of an exemplary operational environment;

FIG. 2 is a diagram of a device binding implementation;

FIGS. 3 and 4 are diagrams of a domain binding implementation;

FIG. 5 is a diagram of a domain binding implementation involving smart cards;

FIG. 6 is a block diagram of a content provider implementation;

FIG. 7 is a block diagram of a remote device implementation;

FIG. 8 is a flowchart illustrating the establishment of a new authorized domain

FIGS. 9 and 10 are flowchart illustrating the joining of a new device to a existing authorized domain; and

FIG. 11 is a diagram of a computer system

### DETAILED DESCRIPTION OF THE PREFERRED EMBODIMENTS

I. Operational Environment

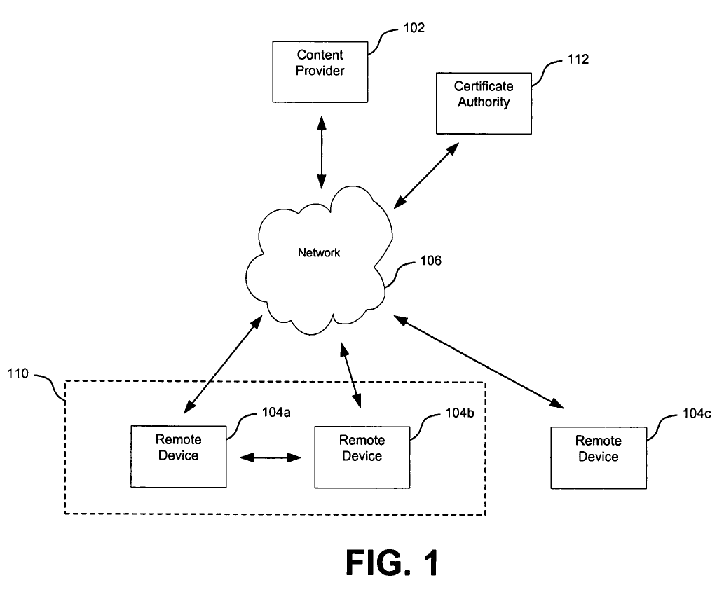

Before describing the invention in detail, it is helpful to describe an environment in which the invention may be used. Accordingly, FIG. 1 is a diagram of an operational environment in which a content provider 102 delivers content to various remote communications devices 104a, 104b, and 104c. This delivery is performed across a communications network 106.

Communications network 106 may be any suitable network (or combination of networks) enabling the transfer of information between content provider 102 and remote devices 104. For instance, communications network 106 may include a broadcast network. Examples of broadcast networks include terrestrial and satellite wireless television distribution systems, such as DVB-T, DVB-C, DVB-H (DVB handheld), ATSC, and ISDB systems. Also, communications network 106 may include broadcast cable networks, such as a Data Over Cable Service Interface Specification (DOCSIS) network. Alternatively, network 106 may include a packet-based network, such as the Internet. As a further example, communications network 106 may include a wireless cellular network that, in addition to voice telephony, allows the transfer of content and data.

Communications network 106 may employ short-range wireless networks, such as personal area networks (PANs) and/or wireless local area networks (WLANs). An exemplary PAN is Bluetooth. Bluetooth defines a short-range radio network, originally intended as a cable replacement. It can be used to create ad hoc networks of multiple devices, where one device is referred to as a master device. Examples of WLAN standards include the IEEE 802.11 standard and the HIPERLAN standard.

Remote communications devices 104 may receive and consume content from content provider 102. Examples of such content include multimedia broadcasts, audio broadcasts, images, video, music, data files, electronic documents, and database entries.

One or more of remote devices 104 may belong to a domain. For instance, FIG. 1 shows that remote devices 104a and 104b belong to an authorized domain 110. Authorized domains, such as domain 110, cover all compliant devices owned or rented by a particular user. Authorized domains may also cover all compliant devices owned by a family, or in some cases, two or more people living together in the same household. By employing authorized domain 110, content is allowed to move freely among devices 104a and 104b so that the user can enjoy the content on any of his or her devices.

As shown in FIG. 1, remote devices 104a and 104b may exchange information with each other. For instance, devices 104a and 104b may exchange content received from content provider 102. In addition, devices 104a and 104b may exchange information related to the establishment of a new domain, or the modification of an existing one. Such communications may be through communications network 106 or through alternative network(s). In embodiments, short range wireless networks may be employed to perform this exchange of information.

The environment of FIG. 1 also includes a certificate authority 112. Certificate authority 112 may create digital certificates for information, such as public encryption keys of remote devices 104. These certificates prove that the public keys actually belong to the remote devices, thereby establishing these devices as trusted entities.

In embodiments, certificate authority 112 creates such a certificate by encrypting a remote device's public key (as well as other identifying information) such that it may be decrypted using the public key of certificate authority 112. This public key is publicly available (e.g., through the Internet). When an entity, such as content provider 102, receives a digital certificate, it may obtain the sender's public key by decrypting the certificate with the certificate authority's public key.

II. Device Binding

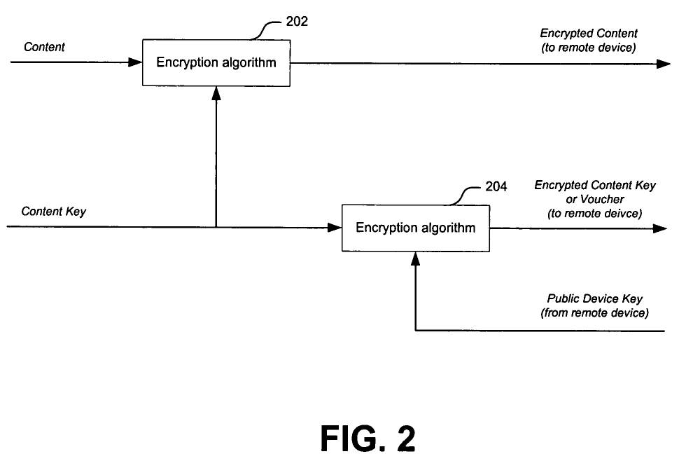

FIG. 2 is a block diagram illustrating a device binding approach in which content is encrypted with a key that is specific to a particular device. As shown in FIG. 2, an encryption algorithm 202 encrypts content with a content key. An asymmetric encryption algorithm 204 encrypts this content key with a public key received from a remote device.

FIG. 2 shows that the encrypted content and encrypted content key are sent to the remote device. In order to consume the content, the remote device must first decrypt the encrypted content key with its private key. Accordingly, this received content can not be shared with other devices.

III. Domain Implementations

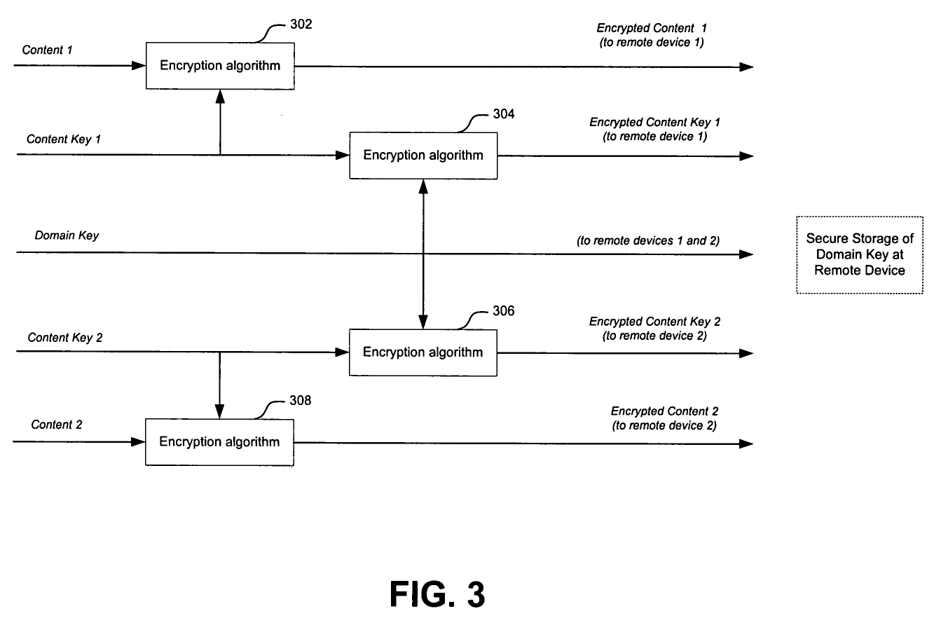

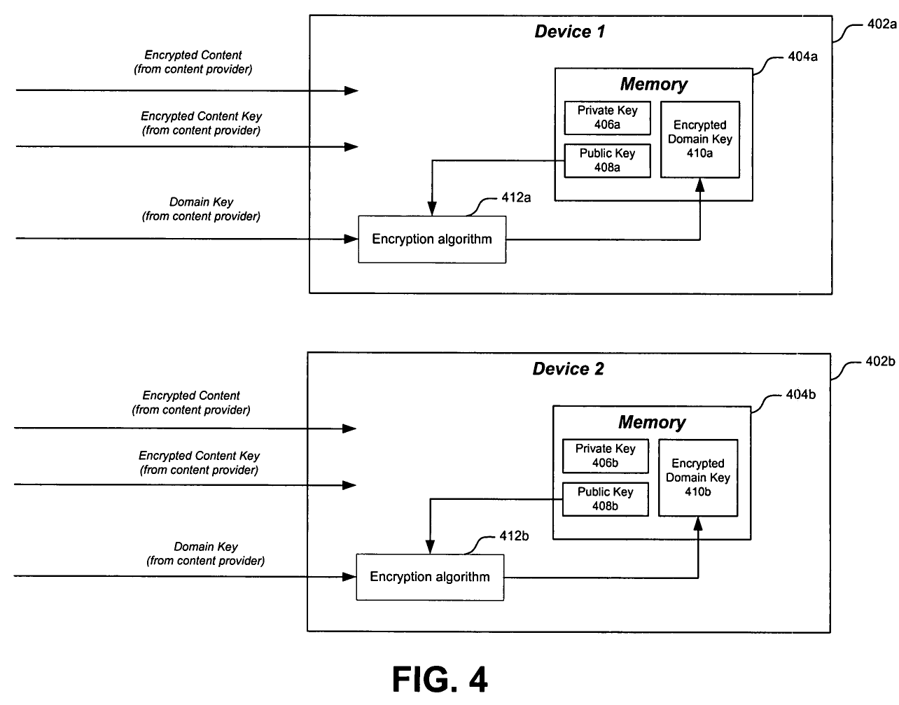

FIGS. 3 and 4 illustrate the use of a domain key, which allows for content to be shared among devices. In particular, FIG. 3 shows encryption algorithms 302 and 308 encrypting content with corresponding content keys. In turn these content keys are each encrypted with a domain key. As shown in FIG. 3, a first encrypted content is sent to a first remote device (shown in FIG. 4 as device 402a), while a second encrypted content is sent to a second remote device (shown in FIG. 4 as device 402b). In addition, the domain key is sent to the two remote devices 402, where it is securely stored.

FIG. 4 shows these remote devices 402 receiving the encrypted content and domain keys. Each of these devices includes a memory containing a private key 406 and a public key 408. Each of these devices encrypts the received domain key with its public key 408 and stores the result in memory 404 as an encrypted domain key 410.

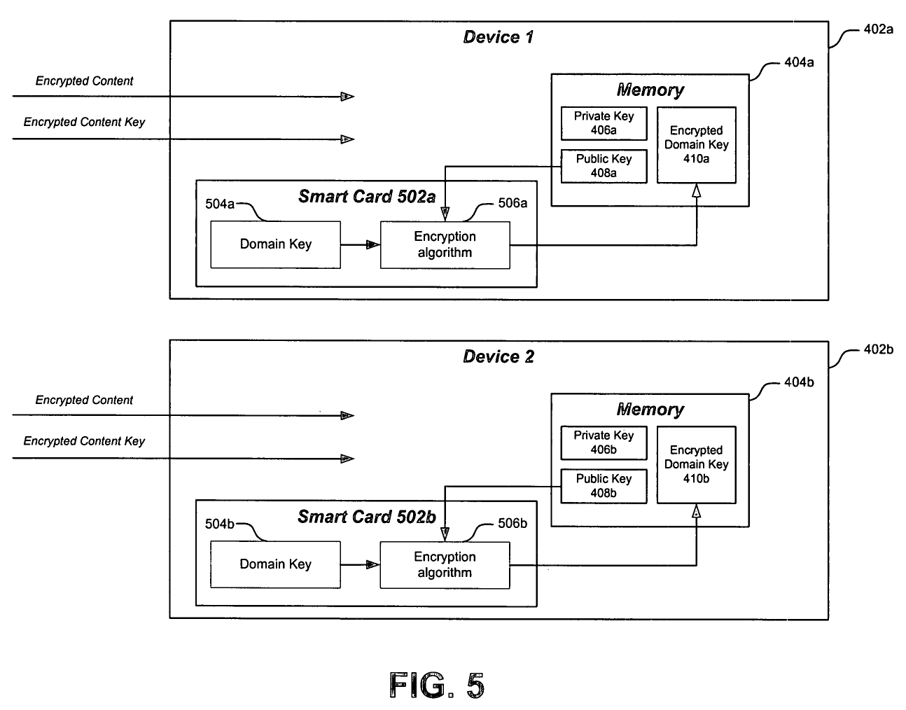

FIG. 5 is similar to FIG. 4. However, in FIG. 5, domain keys are not transmitted to the remote devices 402. Instead, as shown in FIG. 5, domain keys 504 are provided by smart cards 502 inserted into the devices 402. Such an approach is described in copending U.S. application Ser. No. 10/124,637, filed on Apr. 16, 2002, entitled “System and Method for Key Distribution and Network Connectivity.” This application is incorporated herein by reference in its entirety.

However, the approach of FIGS. 3-5 do not illustrate mechanisms for establishing a domain or the addition of devices to existing domains.

IV. Authorized Domain Establishment and Modification

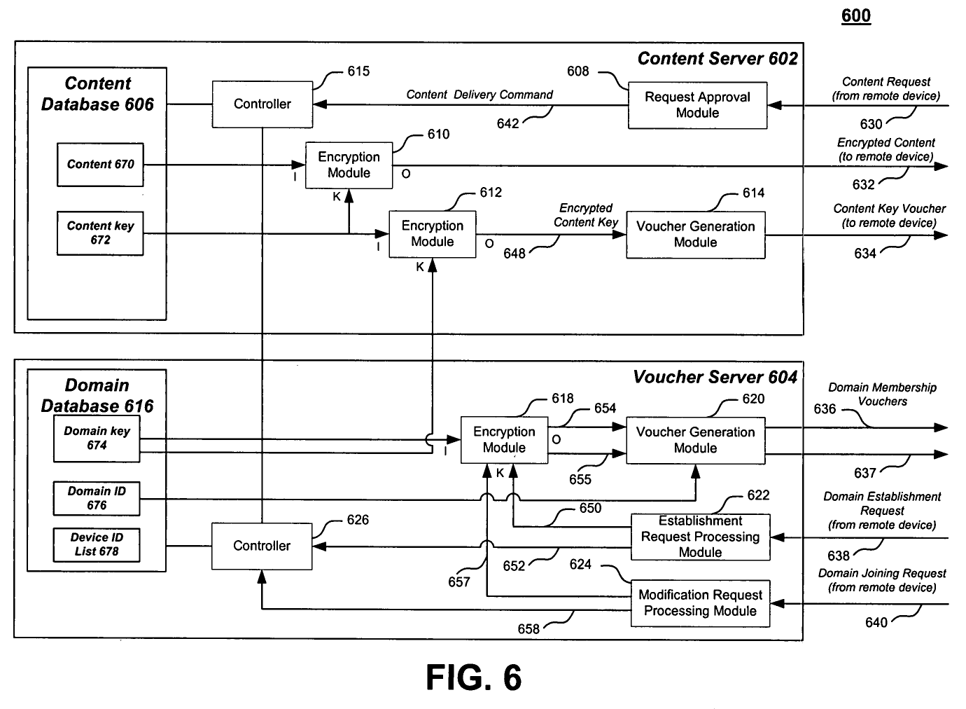

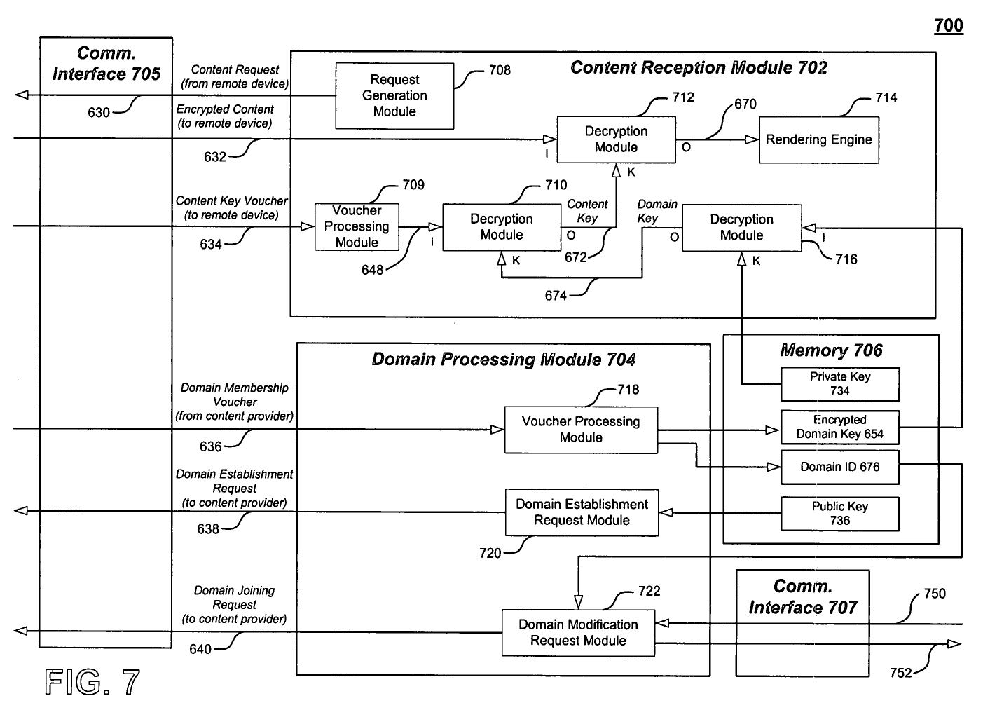

FIGS. 6 and 7 illustrate implementations of a content provider and a communications device. These devices employ techniques that involve requests for domain membership and requests to join existing domains. Accordingly, these implementations may be employed in the operational environment of FIG. 1.

As shown in FIG. 6, a content provider implementation 600 includes a content server portion 602, and a voucher server portion 604. These portions may be implemented in hardware, software, firmware, or any combination thereof. FIG. 6 shows that content server 602 includes a content database 606, a controller 615, encryption modules 610 and 612, a request approval module 608, and a voucher generation module 614. Voucher server 604 includes a domain database 616, a controller 626, an encryption module 618, a voucher generation module 620, an establishment request processing module 622, and a modification request processing module 624.

Content database 606 stores content as well as other information, such as associated encryption keys. For instance, FIG. 6 shows that content database 606 stores a content item 670 and a corresponding content key 672.

Domain database 616 stores domain keys and corresponding domain IDs. As an example, FIG. 6 shows that domain database 616 includes a domain key 674 and a corresponding domain ID 676. Also, FIG. 6 shows that domain database 616 includes a device ID list 678. Device ID list 678 contains identifiers of remote devices within the domain specified by domain ID 676. These identifiers may be network addresses.

As shown in FIG. 6, each of encryption modules 610, 612, and 618 has an input interface (indicated with an “I”) for receiving data, and an input interface (indicated with a “K”) for receiving an encryption key. In addition, each of these modules includes an output interface (indicated with an “O”) for outputting encrypted data. In embodiments, encryption modules 610 and 612 perform encryption according to symmetric encryption algorithms, while encryption module 618 performs encryption according to an asymmetric encryption algorithm (e.g., RSA).

Controller 615 controls operation of content server 602, while controller 626 controls operation of voucher server 604. For instance, controllers 615 and 626 manage access to databases 606 and 616, respectively. As shown in FIG. 6, controller 615 is coupled to controller 626. This allows for content server 602 and voucher server 604 to operate together. For example, this allows content server 602 to receive proper domain keys from domain database 616 when encrypting content keys during the delivery of content.

Request approval module 608 receives content requests from remote devices, and determines whether they are valid. For instance, such requests may include a public key of the remote device, its domain ID, and/or its corresponding domain key. These keys may be embedded in or accompanied by a certificate proving that they belong to trusted devices. In addition, the request may include electronic payment information for the requested content. Module 608 determines whether the request is valid. For example, a valid request is one that has been properly paid for and is from a trusted device.

Upon determining that a request is valid, module 608 issues a command that causes the delivery of protected content and a corresponding content key to the requesting device. This corresponding content key may be included in a content key voucher generated by voucher generation module 614. Module 614 places an encrypted content key and other information, such as a pointer to the corresponding content, in the voucher.

Establishment request processing module 622 receives requests from remote devices to establish new domains. Such requests may include a public key of the requesting device and a certificate proving that the key belongs to a trusted device. Module 622 determines whether such public keys are from valid certificate authority. If so, module 608 issues a command that causes the establishment of a domain. This establishment involves the creation of a domain ID and a corresponding domain key. This information is stored in domain database 616. Once a domain is established, a domain membership voucher is generated by voucher generation module 620 and sent to the requesting device.

This voucher includes the domain ID and the domain key. In embodiments, the domain key is encrypted with a public key of the requesting device. The domain ID may also be encrypted with this key. In addition, the domain membership voucher may include usage rules and/or temporal constraints. Such rules and constraints dictate the manner in which devices may receive and utilize content.

For example, the domain membership voucher may include an expiration time indicating when the domain membership expires. Such a constraint requires domain membership renewal, for example, once every year. This feature advantageously discourages users from misusing the domain membership, for instance, by copying all of their content to a device having a large built-in storage (e.g. hard disk), and subsequently selling the device to someone else. By employing an expiration time, all content stored on the device that is bound to that particular domain will become unusable when the membership expires. This discourages the purchase of second hand devices that are already loaded with content.

Also, the domain membership voucher may specify geographical constraints. Such constraints make content in the domain available when a device can determine that it is located within a region specified by the geographical constraint. For such geographical constraints, the domain membership voucher may specify acceptable ways for a remote device to determine its location. Alternatively, a device may be informed of such acceptable ways through other means. One way in which a remote device may determine its location involves a global positioning system (GPS) receiver. Another way involves receiving location data from a network, such as a broadcasting network or a cellular network.

Such constraints of the domain membership voucher may be expressed, for example in, in an XML-based markup language such as the Open Digital Rights Language (ODRL). Similar techniques may be employed to establish constraints in a content voucher related to the usage rights of a particular piece of content. However, when constraints are specified in a domain membership voucher, they apply to the membership of the device in a domain. This simultaneously affects the usage of all content stored in the domain.

Modification request processing module 624 receives requests from remote devices to modify existing domains. For example, module 624 may receive requests for devices to be added to particular domains. Such requests may include a Domain ID, a device public key, as well as a certificate proving that the public key belongs to a trusted device.

Upon approval of such a request, module 624 generates a command that results in a new device being added to the domain and a domain membership voucher being generated by module 620. This voucher is then sent to the new device.

For purposes of illustration, FIG. 6 shows the processing of a received content request 630, which results in the transmission of encrypted content 632 and corresponding content key voucher 634. As shown in FIG. 6, request approval module 608 receives content request 630 from the remote device. Request 630 specifies a particular content item offered by content provider 600. In addition, this request may include an electronic payment, previous payment information, or subscription information necessary for the delivery of the requested content. Upon approval of this request, module 608 generates a content delivery command 642, which is sent to controller 615.

Upon receipt of command 642, controller 615 generates a query, which is sent to content database 606. This query specifies a particular content item identified in request 630 (e.g., content item 670). In response to this query, content database 606 sends content item 670 and content key 672 to encryption module 610. As a result, encryption module 610 generates encrypted content 632.

Controller 615 indicates to controller 626 that the remote device is requesting content. This results in controller 626 sending a query to domain database 616 for the domain key of the remote device's domain. In response to this query, domain database 616 sends corresponding domain key 674 to encryption module 612. As a result, encryption module 612 generates encrypted content key 648.

As shown in FIG. 6, encrypted content key 648 is sent to voucher generation module 614. Voucher generation module 614 places encrypted content key 648, as well as other information (such as a pointer to the associated content as well as any usage rules), into a content key voucher 634. Content key voucher 634 is sent to the device that requested the associated content.

Also, FIG. 6 shows the processing of a received domain establishment request 638, which results in the transmission of domain membership voucher 636. As shown in FIG. 6, module 622 receives request 638 from a remote device, such as the device described with reference to FIG. 7. Request 638 includes a public key of the requesting device. The public key may be embedded in or accompanied by a certificate from a trusted certificate authority.

Module 622 may approve the request if the public key in request 638 is validated. Upon approval of the request, module 622 sends the public key (650) to encryption module 618 and a domain establishment command 652 to controller 626. Controller 626 assigns domain ID 676 and domain key 674, which are stored in domain database 616. In addition, the requesting device's ID is placed into device ID list 678. Domain key 674 is sent to encryption module 618, where it is encrypted with public key 650 to produce an encrypted domain key 654.

Voucher generation module 620 receives encrypted domain key 654 and domain ID 676. This information is placed into domain membership voucher 636. In addition, voucher generation module 620 may place information (such as usage rules) into domain membership voucher 636. As shown in FIG. 6, domain membership voucher 636 is sent to the requesting device.

FIG. 6 also shows the processing of a domain joining request 640 received from a remote device, such as the device of FIG. 7. From this request, voucher server 604 generates a domain membership voucher 637, which is sent to the remote device desiring membership in the domain. More particularly, module 624 receives request 640 from a remote device, such as the device described with reference to FIG. 7. Request 640 includes a domain ID (i.e., domain ID 676), a public key of the device to added, as well as a certificate proving that the public key belongs to a trusted device.

Upon approval of the request, module 624 sends the public key (657) to encryption module 618 and a domain joining command 658 to controller 626. Controller 626 inserts the originating device's ID into device list 678, which is stored in domain database 616. Domain key 674 is sent to encryption module 618, where it is encrypted with public key 657 to produce an encrypted domain key 655.

Voucher generation module 620 receives encrypted domain key 655 and domain ID 676. This information (as well as any usage rules) are placed into domain membership voucher 637, which is sent to the device desiring membership in the domain.

Although not shown, the content provider of FIG. 6 may include one or more communications interfaces providing for the exchange of information with remote devices, such as the remote device implementation of FIG. 7. Such interfaces may be implemented in hardware, software, firmware, or any combination thereof.

FIG. 7 is a diagram illustrating an implementation 700 of a remote communications device that receives content from a content provider. In addition, this implementation employs techniques involving domain membership requests and requests to join existing domains As shown in FIG. 7, this implementation includes a content reception module 702, a domain processing module 704, a memory 706, a first communications interface 705, and a second communications interface 707. These portions may be implemented in hardware, software, firmware, or any combination thereof.

The device implementation of FIG. 7 may interact with the content provider implementation of FIG. 6. Accordingly, FIG. 7 shows the generation and processing of the requests described with reference to FIG. 6 from the requesting device's perspective.

As shown in FIG. 7, memory 706 stores a private encryption key 734 and a corresponding public encryption key 736, which are associated with the device. In addition, memory 706 stores encrypted domain key 654 and domain ID 676. Memory 706 may also store usage rules and/or constraints (not shown) associated with the domain specified by domain ID 676. FIG. 7 shows that encrypted domain key 654 and domain ID 676 are established through domain establishment request 638, which is generated by domain processing module 704.

Domain processing module 704 includes a voucher processing module 718, a domain establishment request module 720, and a domain modification request module 722. FIG. 7 shows that domain establishment request module 720 generates domain establishment request 638. As described above, request 638 includes public key 736.

Request 638 is sent to the content server of FIG. 6 and processed in the manner described above with reference to FIG. 6. In response, the device receives domain membership voucher 636, which is sent to voucher processing module 718. As described above with reference to FIG. 6, voucher 636 includes encrypted domain key 654 and domain ID 676. In addition, domain membership voucher 637 may include usage rules and/or constraints. Accordingly, module 718 retrieves this information and sends it to memory 706 for storage.

The device of FIG. 7 may also interact with other devices to modify its domain. For instance, domain processing module 704 may receive a domain joining request 750 from a device that wishes to join the same domain as device 700. In particular, domain modification request module 722 receives request 750 and domain ID 676 from memory 706. From these inputs, module 722 generates domain joining request 640, which is sent to the content provider. As described above with reference to FIG. 6, domain joining request 640 results in a domain membership voucher 637 being sent to the device desiring membership in the domain.

In addition to receiving domain joining request 750, domain modification request module 722 may generate a domain joining request 752 and transmit it to another device, where it will be forwarded to a content provider and processed similarly.

Content reception module 702 includes a request generation module 708, a voucher processing module 709, and a rendering engine 714. In addition, content reception module 702 includes decryption modules 710, 712, and 716. Each of these decryption modules has an input interface (indicated with an “I”) for receiving encrypted data, and an input interface (indicated with a “K”) for receiving a decryption key. In addition, each of these modules includes an output interface (indicated with an “O”) for outputting decrypted data. In embodiments, decryption modules 710 and 712 perform decryption according to symmetric encryption algorithms, while decryption module 716 performs decryption according to an asymmetric encryption algorithm (e.g., RSA).

FIG. 7 shows that request generation module 708 generates content request 630, which is sent to a content provider (such as the content provider implementation of FIG. 6). As described above with reference to FIG. 6, content request 630 specifies a particular content item, and may include, for example, payment information. Content request 630 is generated in accordance with rules and/or constraints specified by the corresponding domain membership voucher. These rules and/or constraints may be stored in memory 706. As described above with reference to FIG. 6, such rules and/or constraints may include temporal constraints (e.g., expiration times) and geographic constraints.

To ensure compliance with geographic constraints, the device of FIG. 7 may determine its location with a GPS receiver (not shown). Such a receiver may be local or connected to the device by a network such as a short-range wireless communications network (e.g., Bluetooth). Alternatively, the remote device of FIG. 7 may determine its location through wireless network(s) (such as broadcasting networks and cellular networks) that transmit location data (e.g., cell identification data). Such data may be used for location determining purposes.

In response to request 630, content reception module 702 receives encrypted content 632 and content key voucher 634. As described above, encrypted content 632 is encrypted with content key 672. Content key voucher 634 contains content key 672 encrypted with domain key 674.

As shown in FIG. 7, decryption module 716 decrypts encrypted domain key 654 with private key 734. This results in domain key 674 being sent to decryption module 710. Voucher processing module 709 extracts encrypted content key 648 from voucher 634 and sends it to decryption module 710. Decryption module 710 decrypts encrypted content key 648 with domain key 674 to produce content key 672.

Content key 672 is sent to decryption module 712 to decrypt encrypted content 632. This decryption results in content 670 being sent to rendering engine 714. Rendering engine 714 outputs content 670 to a user output device (not shown) that may include, for example, one or more displays and one or more speakers.

As described above, the device implementation of FIG. 7 includes communications interfaces 705 and 707. Interface 705 provides for the exchange of information with content providers across a network, such as communications network 106. Interface 707 provides for the exchange of information with other remote communications devices. Although FIG. 7 shows two interfaces, the device of FIG. 7 may include several communications interfaces to accommodate communications across several types of networks. Accordingly, these interfaces may be implemented in hardware, software, firmware, or any combination thereof. Thus, these interfaces may include electronics and components, such as antennas.

V. Domain Establishment

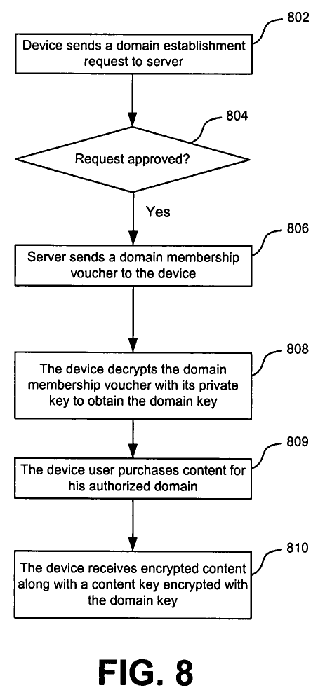

FIG. 8 is a flowchart showing an operational sequence involving the establishment of a new authorized domain by a user of a remote device. This sequence begins with a step 802. In this step, the remote device sends a domain establishment request to the service provider's server (also referred to herein as the voucher server). This request includes the public key of the device and a certificate obtained from a certificate authority. This certificate proves that the key belongs to a trusted device.

In a step 804, the server determines whether the certificate is valid. This step may comprise determining whether the certificate has been revoked. If so, then the server deletes the request and the server may informed the device regarding this deletion. If the certificate is valid, and the server otherwise approves the request, then operation proceeds to a step 806.

In step 806, the server sends (issues) a domain membership voucher, which specifies a domain. At this point, the device belongs to the specified domain. The domain membership voucher includes various information, such a public domain ID, and a secret domain key that the voucher server has assigned to the domain. The domain key may be encrypted with a public key of the requesting device. In addition, the domain membership voucher may include one or more usage rules specifying constraints of the domain membership, such as expiration time(s) and geographic constraints.

In a step 808, the device decrypts the encrypted domain key with its private key to obtain the domain key.

In a step 809, the user purchases from an associated content server content for his or her authorized domain instead of just for a single device. This step may comprise transmitting a request to the associated content server. In embodiments, such a request may be transmitted only in accordance with one or more usage rules and/or constraints associated with the authorized domain. As described above, such rules and constraints may specify geographical and/or temporal limitations.

In a step 810, the user's device receives protected content along with a content voucher. The content voucher contains a content key that is encrypted with the domain key instead of the public device key.

VI. Adding Domain Devices

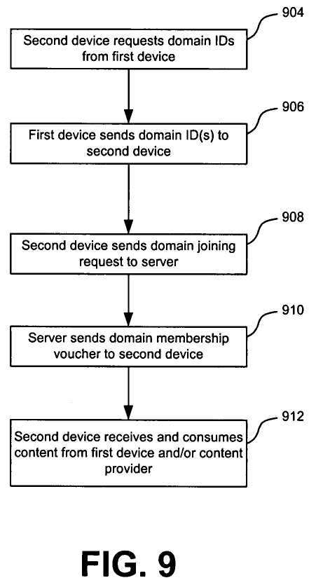

As described above, domains can be identified by Domain IDs. This facilitates the joining of additional devices to an existing domain. FIG. 9 is a flowchart of an operational sequence involving an additional device joining a preexisting domain according to a first approach.

This sequence begins with a step 904. In this step, a second device sends a request to a first device. This request inquires to which domain(s) the first device belongs. In response to this request, the first device sends one or more of its domain IDs to the second device in a step 906.

In a step 908, the second device sends a domain joining request to a voucher server. This request includes one or more domain IDs, a public key of the second device, as well as a certificate obtained from a certificate authority proving that the public key belongs to a trusted device.

In a step 910, the server responds to the request by sending to the second device one or more domain membership vouchers corresponding to the domain ID(s) sent in step 908. This voucher includes a domain ID and a corresponding domain key. The domain key (and possibly the domain ID) is encrypted with a public key of the second device. This voucher can not be intercepted because the domain membership voucher can only be decrypted with the private key of the second device.

In a step 912, the second device may receive and consume content from either associated content servers or other devices within the domain it is a member of. This step may comprise transmitting a request for the content. In embodiments, such a request may be transmitted only in accordance with one or more usage rules and/or constraints associated with the authorized domain. As described above, such rules and constraints may specify geographical and/or temporal limitations.

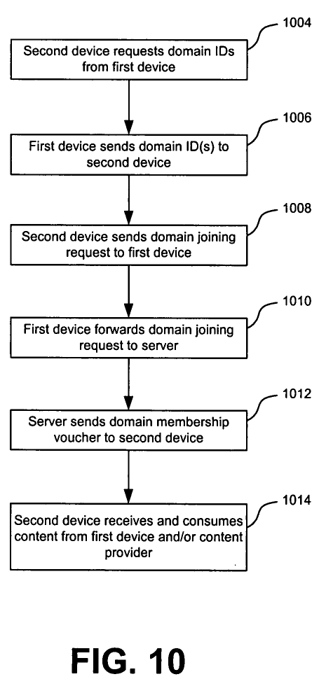

FIG. 10 is a flowchart of an operational sequence involving an additional device joining a preexisting domain according to a second approach. This sequence begins with a step 1004. In this step, a second device sends a request to a first device. This request inquires to which domain(s) the first device belongs.

In response to this request, the first device sends one or more of its domain IDs to the second device in a step 1006.

In a step 1008, the second device sends a domain joining request to the first device. This request includes a public key of the second device, as well as a certificate associated with this key.

In a step 1010, the first device adds its domain ID to the request and sends it to a voucher server. In a step 1012, the server responds to the request by sending to the second device the domain membership voucher. This voucher includes a domain ID and a corresponding domain key. The domain key (and possibly the domain ID) is encrypted with a public key of the second device. This voucher can not be intercepted because the domain membership voucher can only be decrypted with the private key of the second device.

In a step 1014, the second device may receive and consume content from either associated content servers or other devices within the domain. This step may comprise transmitting a request for the content. In embodiments, such a request may be transmitted only in accordance with one or more usage rules and/or constraints associated with the authorized domain. As described above, such rules and constraints may specify geographical and/or temporal limitations.

VII. Computer System

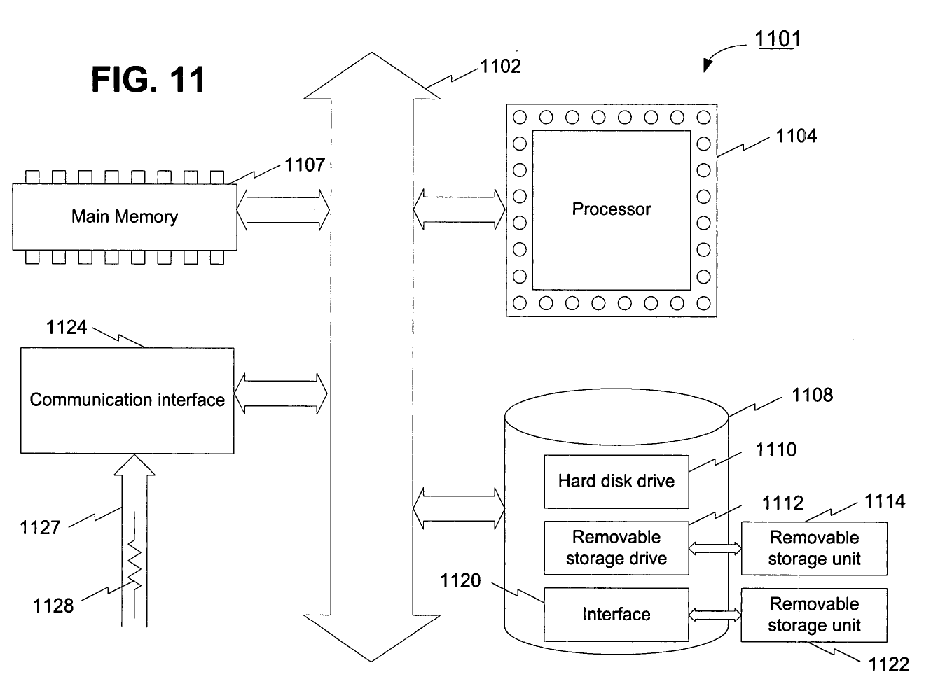

As described above, the content provider and communications devices described herein may be implemented in hardware, software, and/or firmware. Such implementations may include one or more computer systems. An example of a computer system 1101 is shown in FIG. 11. Computer system 1101 represents any single or multi-processor computer. Single-threaded and multi-threaded computers can be used. Unified or distributed memory systems can be used.

Computer system 1101 includes one or more processors, such as processor 1104. One or more processors 1104 can execute software implementing the process described above with reference to FIGS. 8-10. Each processor 1104 is connected to a communication infrastructure 1102 (for example, a communications bus, cross-bar, or network). Various software embodiments are described in terms of this exemplary computer system. After reading this description, it will become apparent to a person skilled in the relevant art how to implement the invention using other computer systems and/or computer architectures.

Computer system 1101 also includes a main memory 1107 which is preferably random access memory (RAM). Computer system 1101 may also include a secondary memory 1108. Secondary memory 1108 may include, for example, a hard disk drive 1110 and/or a removable storage drive 1112, representing a floppy disk drive, a magnetic tape drive, an optical disk drive, etc. Removable storage drive 1112 reads from and/or writes to a removable storage unit 1114 in a well known manner. Removable storage unit 1114 represents a floppy disk, magnetic tape, optical disk, etc., which is read by and written to by removable storage drive 1112. As will be appreciated, the removable storage unit 1114 includes a computer usable storage medium having stored therein computer software and/or data.

In alternative embodiments, secondary memory 1108 may include other similar means for allowing computer programs or other instructions to be loaded into computer system 1101. Such means can include, for example, a removable storage unit 1122 and an interface 1120. Examples can include a program cartridge and cartridge interface (such as that found in video game devices), a removable memory chip (such as an EPROM, PROM, or flash memory) and associated socket, and other removable storage units 1122 and interfaces 1120 which allow software and data to be transferred from the removable storage unit 1122 to computer system 1101.

Computer system 1101 may also include one or more communications interfaces 1124. Communications interface 1124 allows software and data to be transferred between computer system 1101 and external devices via communications path 1127. Examples of communications interface 1127 include a modem, a network interface (such as Ethernet card), a communications port, etc. Software and data transferred via communications interface 1127 are in the form of signals 1128 which can be electronic, electromagnetic, optical or other signals capable of being received by communications interface 1124, via communications path 1127. Note that communications interface 1124 provides a means by which computer system 1101 can interface to a network such as the Internet.

The present invention can be implemented using software running (that is, executing) in an environment similar to that described above with respect to FIG. 11. In this document, the term “computer program product” is used to generally refer to removable storage units 1114 and 1122, a hard disk installed in hard disk drive 1110, or a signal carrying software over a communication path 1127 (wireless link or cable) to communication interface 1124. A computer useable medium can include magnetic media, optical media, or other recordable media, or media that transmits a carrier wave or other signal. These computer program products are means for providing software to computer system 1101.

Computer programs (also called computer control logic) are stored in main memory 1107 and/or secondary memory 1108. Computer programs can also be received via communications interface 1124. Such computer programs, when executed, enable the computer system 1101 to perform the features of the present invention as discussed herein. In particular, the computer programs, when executed, enable the processor 1104 to perform the features of the present invention. Accordingly, such computer programs represent controllers of the computer system 1101.

The present invention can be implemented as control logic in software, firmware, hardware or any combination thereof. In an embodiment where the invention is implemented using software, the software may be stored in a computer program product and loaded into computer system 1101 using removable storage drive 1112, hard drive 1110, or interface 1120. Alternatively, the computer program product may be downloaded to computer system 1101 over communications path 1127. The control logic (software), when executed by the one or more processors 1104, causes the processor(s) 1104 to perform the functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant art(s).

### VIII. Conclusion

While various embodiments of the present invention have been described above, it should be understood that they have been presented by way of example only, and not in limitation.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. A method of establishing an authorized domain, the method comprising:
(a) receiving a domain establishment request from a remote device, the request including a public key of the remote device; ad
(b) sending to the remote device a domain identifier and a domain key encrypted with the public key, wherein the domain key is adapted to decrypt a content key that encrypts content authorized for consumption within the authorized domain.

2. The method of claim 1, wherein step (b) comprises sending the domain identifier and the domain key in a voucher.

3. The method of claim 2, wherein the voucher includes a domain membership expiration time.

4. The method of claim 2, wherein the voucher includes a geographical constraint specifying a region in which content is available.

5. The method of claim 1, wherein the request includes a certificate indicating that the public key belongs to a trusted device.

6. The method of claim 5, further comprising determining whether the certificate is valid.

7. A method of adding a remote device to an authorized domain, the method comprising:
(a) receiving a domain joining request including a domain identifier and a public key of the remote device; and
(b) sending to the remote device a domain key encrypted with the public key, wherein the domain key is adapted to decrypt a content key that encrypts content authorized for consumption within the authorized domain.

8. The method of claim 7, wherein step (a) comprises receiving the domain joining request from the remote device.

9. The method of claim 7, wherein step (a) comprises receiving the domain joining request from a second remote device currently belonging to an authorized domain specified by the domain identifier.

10. The method of claim 7, wherein step (b) comprises sending the domain key in a voucher.

11. The method of claim 10, wherein the voucher includes a domain membership expiration time.

12. The method of claim 10, wherein the voucher includes a geographical constraint specifying a region in which content is available.

13. The method of claim 7, wherein the request includes a certificate indicating that the public key belongs to a trusted device.

14. A system for establishing an authorized domain, the system comprising:
means for receiving a domain establishment request from a remote device, the request including a public key of the remote device; and
means for sending to the remote device a domain identifier and a domain key encrypted with the public key, wherein the domain key is adapted to decrypt a content key that encrypts content authorized for consumption within the authorized domain.

15. The system of claim 14, wherein means for sending comprises means for sending the domain identifier and the domain key in a voucher.

16. The system of claim 15, wherein the voucher includes a domain membership expiration time.

17. The system of claim 15, wherein the voucher includes a geographical constraint specifying a region in which content is available.

18. The system of claim 14, wherein the request includes a certificate indicating that the public key belongs to a trusted device.

19. The system of claim 18, further comprising means for determining whether the certificate is valid.

20. A system for adding a remote device to an authorized domain, the system comprising:
means for receiving a domain joining request including a domain identifier and a public key of the remote device; and
means for sending to the remote device a domain key encrypted with the public key, wherein the domain key is adapted to decrypt a content key that encrypts content authorized for consumption within the authorized domain.

21. The system of claim 20, wherein said means for receiving comprises means for receiving the domain joining request from the remote device.

22. The system of claim 20, wherein said means for receiving comprises means for receiving the domain joining request from a second remote device currently belonging to an authorized domain specified by the domain identifier.

23. The system of claim 20, wherein said means for sending comprises sending the domain key in a voucher.

24. The system of claim 23, wherein the voucher includes a domain membership expiration time.

25. The system of claim 23, wherein the voucher includes a geographical constraint specifying a region in which content is available.

26. The system of claim 20, wherein the request includes a certificate indicating that the public key belongs to a trusted device.

27. A system, comprising:
a first module adapted to assign a domain identifier and a domain encryption key for an authorized domain, wherein the domain encryption key is adapted to encrypt keys for encrypting content authorized for consumption within the authorized domain; and
a second module adapted to generate a domain membership voucher, the domain membership voucher including the domain key encrypted with the public key of the remote device and the domain identifier.

28. The system of claim 27, wherein the second module is adapted to generate the domain membership voucher in response to a domain membership request received from the remote device, the domain membership request including the public key of the remote device.

29. The system of claim 27, wherein the second module is adapted to generate the domain membership voucher in response to a domain joining request, the domain joining request including the public key of the remote device.

30. The system of claim 27, further comprising:
a content database adapted to store a content item; and
a module adapted to transmit to a device within an authorized domain a content key encrypted with the domain key and the content item encrypted with the content key.

31. A method of establishing an authorized domain in a communications device, the method comprising:
(a) sending a domain establishment request to a server, the request including a public key of the communications device; and
(b) receiving from the server a domain identifier and a domain key encrypted with the public key, wherein the domain key is adapted to decrypt a content key that encrypts content authorized for consumption within the authorized domain.

32. A system for establishing an authorized domain in a communications device, the system comprising:
means for sending a domain establishment request to a server, the request including a public key of the communications device; and
means for receiving from the server a domain identifier and a domain key encrypted with the public key, wherein the domain key is adapted to decrypt a content key that encrypts content authorized for consumption within the authorized domain.

33. A method of adding a communications device to an authorized domain, the method comprising:
(a) sending a domain joining request including a domain identifier and a public key of the communications device; and
(b) receiving from a server a domain key encrypted with the public key, wherein the domain key is adapted to decrypt content authorized for consumption within the authorized domain.

34. The method of claim 29, wherein step (a) comprises sending the domain joining request to the server.

35. The method of claim 29, wherein step (a) comprises sending the domain joining request to a remote communications device currently in the authorized domain.

36. A system for adding a communications device to an authorized domain, the system comprising:
means for sending a domain joining request including a domain identifier and a public key of the communications device; and
means for receiving from a server a domain key encrypted with the public key, wherein the domain key is adapted to decrypt a content key that encrypts content authorized for consumption within the authorized domain.
